(19) United States
(12) Patent Application Publication
(10) Pub. No.: US 2008/0067345 A1
(43) Pub. Date: Mar. 20, 2008

(54) Method for creating multiply charged ions for MALDI mass spectrometry (ESMALDI)

(76) Inventor: John B. Fenn, (US)

Correspondence Address: JOSEPH J. BANGO;c/o CONNECTICUT ANALYTICAL CORPORATION, 696 Amity Road, Route 63, Bethany, CT, 06524, US

(21) Appl. No.: 11/786,849

(22) Filed: Apr. 14, 2007

Related U.S. Application Data
(60) Provisional application No. 60/792,152, filed on Apr. 15, 2006.

(51) Int. Cl. B01D 59/44

(52) U.S. Cl. 250/282

(57) ABSTRACT

A method of combining ES (ElectroSpray Ionization) and MALDI (Matrix Assisted Laser Desorption Ionization) to create enhanced MALDI mass spectrometry to be referred to as ESMALDI (ElectroSpray Matrix Assisted Laser Desorption Ionization). ESMALDI technology offers substantial advantages over conventional technology. essentially by combining the high ionization efficiency and multiple charging of ions in ESI with the smaller sample requirements and operational simplicity of MALDI. Biologists should thus be able to achieve higher sensitivity, better protein identification, enhanced quantification potential and enhanced structural information. An additional degree of freedom for ESMALDI MS is flexibility in the choice of solvents that can be used in the ESI component of the process. Substantial differences in ESI behavior can occur with the same analyte or mixture of analytes in different solvents. Such differences often provide clues to the properties of the analyte and its ions which cannot be readily obtained from conventional MALDI experiments.

### CROSS REFERENCE TO RELATED APPLICATIONS

Provisional Patent Application No. 60/792152 filed on Apr. 15, 2006

### BACKGROUND

1. Field of Invention

This invention relates in general to mass spectrometry (MS), and specifically to MALDI (Matrix Assisted Laser Desorption Ionization) mass spectrometry. In conventional MALDI mass spectrometry, a matrix of some protonated UV (ultraviolet) absorbing material is mixed with the sample to be analyzed. When a UV laser desorbs the combination matrix and sample material, the result is a vaporization and ionization of the sample material. The reason for using the matrix material is so that sample substances that are not easily desorbed, can be much more easily desorbed and subsequently ionized.

2. Background Description of Prior Art

In the pursuit of analyzing and understanding the composition of chemical substances, a means must be found to enable nuetral molecules to be changed into intact gas phase ions. These gas phase ions will be charged with either a net positive or negative. charge. To perform this type of analysis, several types of mass spectrometry have been devised. Toward the end of the last century two new methods were developed for producing large intact ions, non-volatile and complex molecules: Electrospray Ionization (ESI) and Matrix Assisted Laser Desorption Ionization (MALDI). The emergence of these techniques has made the power and elegance of Mass Spectrometry (MS) readily applicable to such fragile species as proteins, nucleic acids and carbohydrates. The result has been a revolution in the ability of investigators to probe the basic reactions and processes that play such a vital role in living systems. The described invention combines advantages of both ESI and MALDI in what hereinafter will be referred to as ESMALDI in recognition of its ancestry. Preliminary experiments strongly suggest that this union will be fruitful.

The underlying idea of this new invention consists in producing ions of the species of interest by the well-established technique of Electrospray Ionization and then depositing those ions on the surface of a capacitor comprising a metal plate coated with a thin layer of electrical insulator on whose surface is a thin lamina of vaporizable matrix material. The resulting “sandwich” constitutes a capacitor that is then charged by the deposition of ES ions on the matrix coating. The resulting charged capacitor is then located at one end of an evacuated flight tube at whose other end of is a rapid-response ion detector just as in a conventional MALDI apparatus. When a focused burst of laser photons impinges on a small area of the ion covered coating of matrix, the resulting puff of vapor includes ESI ions from that small area into the space above the surface where they are released by appropriate gating electrodes and accelerated down a flight tube by an imposed electric field, just as in a conventional MALDI-TOF (Time Of Flight) mass spectrometer. The rapid response detector at the other end of the flight tube, records the arrival times of the ion packets, thereby providing the information sufficient to determine the mass/charge ratios of those ions, again just as in conventional MALDI mass spectrometry. It is noteworthy that in this procedure the matrix material does not have responsibility for charging the analyte molecules, as in conventional MALDI, but serves only as a source of the vapor required to lift already formed ES ions from the surface of the “capacitor” into the flight tube. Consequently, there is a much wider variety of materials from which prospective matrices can be selected, than is the case for conventional MALDI in which the matrix vapor must also ionize the analyte species.

Also, to be noted is that as soon as a deposited ion is lifted only slightly above the capacitor surface it will be repelled by the charges remaining on that surface and thus free to be accelerated down the flight tube by the field produced by appropriately mounted electrodes.

MALDI mass spectrometry is a relatively young technique for ionization. MALDI's initial public debut was due to a paper published in 1985 by Karas and Hillenkamp. Initially the MALDI technique allowed for only the ionization of small organic molecules, such as amino acids. Many improvements have been made since MALDI's debut and one researcher in particular, Koichi Tanaka of Japan, received the Nobel Prize in 2002 for his contributions to the science. MALDI is no longer limited to small organic molecules due to the many contributions of various researchers. As previously stated, one drawback of the MALDI technique is due to the lack of creating multiply charged ions, i.e. the efficiency is not as high as would be preferred. Other mass spectrometric techniques, such as ESI (ElectroSpray Ionization) create multiply charged ions, and hence result in greater sensitivity and sharper mass to charge peaks, i.e. greater efficiency. To make a more efficient and effective MALDI process, a method of producing multiply charged ions will be described.

In addition to spraying a solution directly onto the charged insulating dielectric, a wicking material could be used to provide fluid delivery. The wicking material could be a material that is used in a typical “Magic Marker”, Highlighter marker, fibrous cloth, or a “Holey Fiber”. Holey fibers are a relatively new class of optical waveguide that use an array of tiny hollow channels to guide light in a novel way. By using these “Holey fibers” as a wicking structure for electrospray applications, highly efficient needle sources could be produced to form a self-regulating hydrostatic feed system. The Idea of using a wick as a self-regulating capillary feed system is not a new one, as it was previously proposed by Dr. John B. Fenn to eliminate the necessity for a hydrostatic feed pump. A high voltage differential is used to promote the electrospray process, depending on the polarity of the electric field used; the ions produced may be positive or negative. The droplets contain both solvent molecules as well as analyte molecules. As the solvent evaporates from the droplet, the droplet becomes smaller while the total charge on the droplet remains the same. As the droplet volume decreases, the concentration of surface charge increases. At a critical point, known as the so-called “Rayleigh limit”, the charged droplet's surface tension can't hold together the high number of surface charges and the droplet explodes into what is known as a Coulomb explosion, producing smaller, still highly charged droplets. As the solvent evaporates form the droplets, the charge is not carried away with it. The resulting shrinking droplet volume causes the surface charge to concentrate, and since “like” charges repel, a resulting droplet fission or breakup is realized. This process repeats itself until eventually the analyte molecule is stripped of all solvent molecules, and is left as a single multiply charged ion. Because the amount of liquid pulled away from the electrospray needle tip must be replaced at a like rate to keep the Taylor cone stable, a major component of any ESI-MS is that of the hydrostatic feed system. The hydrostatic feed system must be capable of delivering a tiny controlled amount (typically microliter [10⁻⁶L] to nanoliter [10⁻⁹ L] quantity) of liquid at a controlled rate to effect a stable Taylor cone. The described invention uses a Holey fiber, or more specifically, a glass optical fiber with micron sized diameter holes running its length to effect a highly efficient wick feed system. The additional benefit of using an optical fiber is the fact that it is made from glass and is therefore a chemically inert material. If a wick material is used that is made from a material that could react with a solvent, then erroneous results could be expected. The wick feed system has the beauty of having no moving parts to break or wear out! By using a small glass fiber with tiny holes, a glass “wick” with a very small diameter could be realized.

### BRIEF DESCRIPTION OF THE DRAWINGS

FIG. 1 shows an image of a small rectangular conductive metal plate and a thin sheet of insulating material coated with a thin lamina of Matrix material.

FIG. 2 shows an image of a small rectangular conductive metal plate and a thin sheet of insulating material applied to the top surface coated with a thin lamina of Matrix material.

FIG. 3 shows a schematic of a linear TOF (Time Of Flight) tube for a linear TOF mass spectrometer indicating various components.

FIG. 4 shows a schematic of a linear TOF (Time Of Flight) tube for a linear TOF mass spectrometer indicating various components and significant dimensions.

FIG. 5 shows a schematic of a linear TOF (Time Of Flight) tube for a linear TOF mass spectrometer indicating various components and significant dimensions and the resulting separation of charged components.

FIG. 6 details a schematic representation of an ESMALDI technique. A high voltage source is connected to a conductive container filled with a solution of analyte and solvent. A wicking material would feed the solution to the end of a hollow needle where a “Taylor cone” would form, and produce a jet of multiply charged ions. These multiply charged ions would then be sprayed onto an insulating dielectric layer coated onto a conductive element that is then coated with a thin lamina of Matrix material. After enough solution is electrosprayed onto the insulating dielectric layer coated with a thin lamina of Matrix material, the high voltage is disconnected and the electrospray process stops. Because the solution is composed of multiply charged ions on an insulating layer, the charge will remain for some time.

FIG. 7 details s schematic representation of an ESMALDI technique. A high voltage source is connected to a conductive container filled with a solution of sample and matrix. A wicking material would feed the solution to the end of a hollow needle where a “Taylor cone” would form, and produce multiply charged ions. These multiply charged ions would then be sprayed onto a charged insulating dielectric layer coated onto a conductive element. After enough solution is electrosprayed onto the charged insulating layer, the high voltage is disconnected and the electrospray process stops. Because the solution is composed of multiply charged ions on an insulating layer, the charge will remain for some time. The charged insulating dielectric electrode combination is then used in the MALDI process where it is hit with a pulse of UV laser light. The result is that instead of singly charged ions being produced, multiply charged ions are produced and are sent into the gas phase to be introduced into a TOF (Time Of Flight) mass spectrometer.

### DETAILED DESCRIPTION OF THE INVENTION

MALDI (Matrix Assisted Laser Desorption Ionization) mass spectrometry is a relatively young technique for ionization. The MALDI technique is a process that enables neutral species that are not easily desorbed—to be desorbed. If one has a mixture containing a highly UV absorbent material (matrix) and a much more difficult UV absorbing material (analyte), then the more difficult material (analyte) will fly along with the easily absorbing matrix material when hit with a UV laser. The addition of the matrix material will enable a neutral material to be sent into the gas phase and be analyzed in a Time of flight mass spectrometer (TOF-MS). The matrix material is a protonated substance (acid) that will provide an ionization of primarily +1. A greater amount of ionization (i.e. a multiply charged ion) is needed to increase the efficiency and sensitivity of the MALDI process. The described invention details how to enable the MALDI technique to produce such multiply charged ions.

The MALDI technique came about as an evolution of a four-decade-old LAMMA device. LAMMA is an acronym meaning (LAser Micropulse Mass Analyzer). The LAMMA device would allow for submicron resolution of masses of inorganic ions via laser desorption from an organic, resin-based matrix. One of the LAMMA developers was a man by the name of Franz Hillenkamp. MALDI's initial public debut was due to a paper published in 1985 by Michael Karas and Franz Hillenkamp. Initially the MALDI technique allowed for only the ionization of small organic molecules, such as amino acids. Many improvements have been made since MALDI's debut, one researcher in particular, Koichi Tanaka of Japan, received the Nobel Prize in 2002 for his contributions to the science. Koichi Tanaka was the -first person to make the MALDI technique work with large proteins. MALDI is no longer limited to small organic molecules due to the many contributions of various researchers. In MALDI, the analyte molecules are dispersed on a surface in a thin layer of matrix, usually an organic acid. The energy of an incident pulse of laser photons is absorbed mostly by the matrix to form a jet of matrix vapor that lifts analyte molecules from the surface and by mechanisms still not well understood, transforms some of them into ions that are mainly singly charged. Because those ions are all produced at a well-defined location in an exceedingly short time, their mass analysis is most effectively achieved by Time-Of-Flight methods. MALDI is one of several ionization methods for biomolecules that promise to dominate the MS scene for the foreseeable future. Recently MALDI-TOF in vacuo has been supplemented by MALDI at atmospheric pressure with subsequent introduction of the resulting ions into any of several types of mass analyzers.

These many contributions and improvements enable the MALDI technique to be used as an invaluable tool for proteomics research. One drawback of the MALDI technique is due to the lack of creating multiply charged ions. Other mass spectrometric techniques, such as ESI (ElectroSpray Ionization) create multiply charged ions, and hence result in greater sensitivity and sharper mass to charge peaks. To make a more efficient and effective MALDI process, a method of producing multiply charged ions will be described.

Mass Spectrometry (MS) is the art of obtaining precise values for the masses of individual atoms and molecules. It is based on endowing such atoms or molecules with a net charge and then determining the masses of the resulting ions from the effect of applied electric and/or magnetic fields on the trajectories of those ions in vacuum. From the beginnings of MS in the landmark experiments of J. J. Thomson in the last century, until relatively late in that century, the production of ions from neutral molecules was generally achieved by bringing about gas phase encounters of those molecules with electrons, photons, or other ions. If those encounters are sufficiently energetic, they can remove one or more electrons from the neutral molecules thereby transforming them into positive ions. More rarely, an electron or ion of sufficiently low energy can attach itself to a neutral molecule to form an ion comprising the neutral molecule with an adduct charge. Because such ionization methods require that the neutral molecules be gaseous, the elegance and precision of mass spectrometric analysis could not be used for the large and complex molecules that play such vital roles in living systems because those molecules could not be vaporized by classical methods without catastrophic decomposition. As the result of intensive efforts beginning in middle of the last century, two relatively new and effective methods of ionizing these large and fragile molecules have emerged: “Electrospray Ionization” (ESI) and “Matrix Assisted Laser Desorption Ionization” (MALDI).

The advantages of ESI are that it can be conveniently coupled directly to instruments that separate complex liquid mixtures into their individual components, e.g. by liquid chromatography or electrophoresis. Moreover, the ES ions produced from large molecules have multiple charges consequently, the mass analyzer need not have as large a dynamic range of mass/charge ratios as would be required if all the ions were singly charged. In addition, the multiple charging on ES ions greatly enhances the amount of structural information that can be obtained by so-called tandem mass spectrometry or MS-MS. In that technique, ions are “weighed” in a first mass analysis step after which they are fragmented by collisions with neutral molecules or a surface. The resulting fragment ions are then “weighed” in a second mass analysis step. The values of mass/charge ratios in such fragments are a rich source of information on the structure and composition of the parent molecule. Although MALDI MS generally requires less sample than does ESI MS, it also produces less structural information because the ions produced rarely have more than one or two charges. Subsequent fragmentation of the ion of a large molecule can therefore provide only one or two charged fragments and thus very limited information on the structure and composition of the parent molecule.

The described Invention aims at producing ions of a sample species, depositing them on a surface that is covered with a thin layer of an appropriate dielectric material that can be vaporized when exposed to a sufficiently intense pulse of photons from a laser. The surface with its coating of ions is then placed at one end of an evacuated. The resulting pulse of ions is then directed at the surface of a detector at a precisely known distance from the source surface. The distribution of time intervals between the firing of the laser pulse and arrival times of the ions at the detector is a measure of the velocity distributions of the ions. From those velocity values and the energies of the ions as determined by the potential difference between the ion source surface and the target elect, one could readily determine the masses of the ions.

Many possible variations on the theme will be apparent to those with reasonable skills in the required arts. The essential components of the system can be readily prepared in the laboratory at atmospheric pressure before evacuation. Nor does the vacuum required for Time-of-Flight mass spectrometry have to be all that high. The main requirement is that the mean free paths for neutral molecules and ions in the system be comfortably larger than the flight paths of the ions from their source to the target surface. Clearly, one can carry out most of the preparation of sources, targets and other components at atmospheric pressure on a bench in the laboratory just before actual measurements of ion flight-times. With only modest pumping speeds the require evacuation can be achieved in a few minutes, just before a measurement to be carried out. Target surfaces from which ions are to be desorbed into the ion flight chamber can be prepared at leisure and stored in a reasonably clean environment until just before use in an actual experiment.

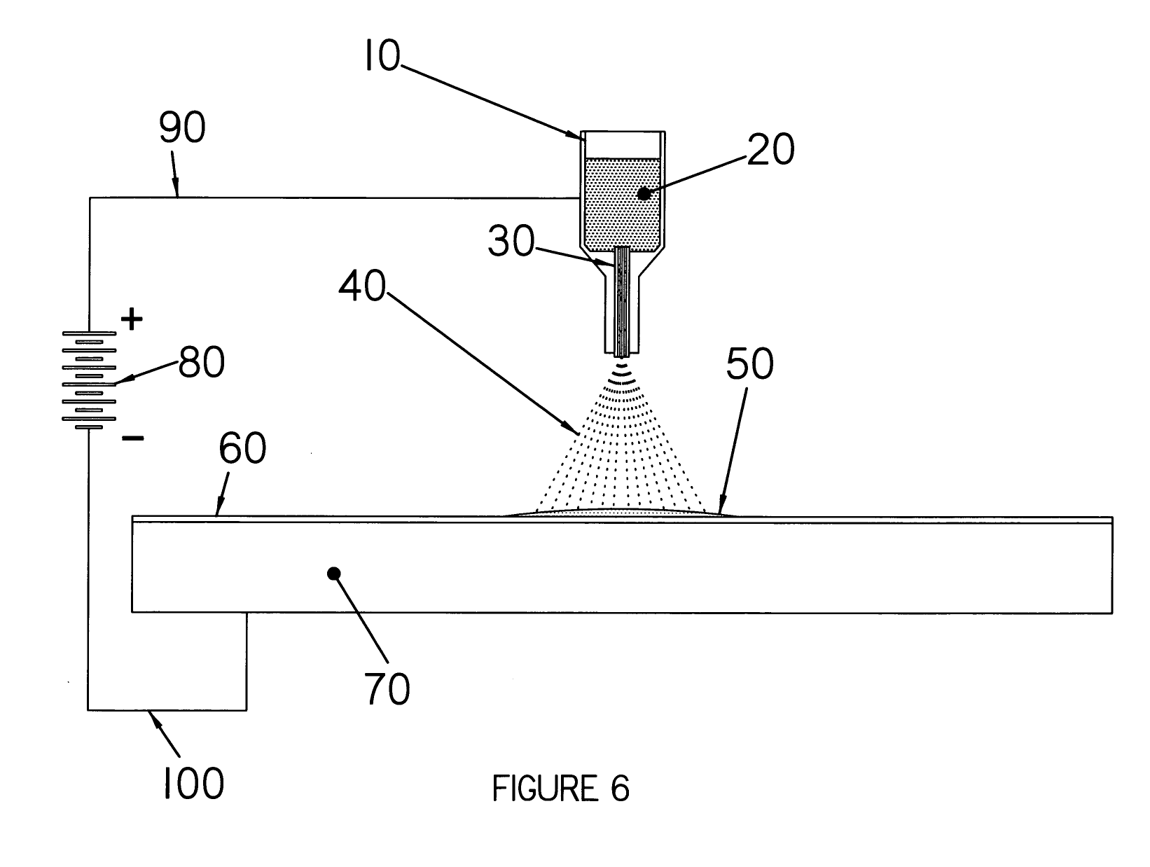

The possibility occurred to us that the advantages of MALDI and ESI might be combined in what we will call ESMALDI for which the essential features are shown in FIG. 6. A high voltage power supply 80 maintains a desired potential difference between Electrospray needle 30 and grounded electrode 70. The resulting intense field at the needle tip disperses the emerging sample liquid into a fine spray of charged droplets, which are driven by the field toward electrode 70 through an appropriately directed flow of dry inert gas such as nitrogen or purified air at an appropriate pressure, e.g. one atmosphere. The gas is not shown, but it should be obvious to those skilled in the art about its use and purpose. By a still much-debated mechanism, evaporation of solvent from the charged droplets results in the formation of free gas phase ions comprising solute molecules with one or more charges, the number depending upon the size and composition of those molecules. The “appropriately directed” flow of dry gas carries evaporated solvent molecules away from the scene. The resulting dry ions are trapped by the field due to the potential difference between ES Needle 30 and Grounded Electrode 70 and deposited on the thin bed of Matrix that covers the surface of dielectric insulator 60 on that grounded electrode 70. The deposition of ions continues until the potential of the ion layer approaches the potential of needle 30. At that point, or slightly earlier, the field at the needle tip becomes too weak to disperse the emerging liquid so the spray ceases. The flow of liquid is then terminated.

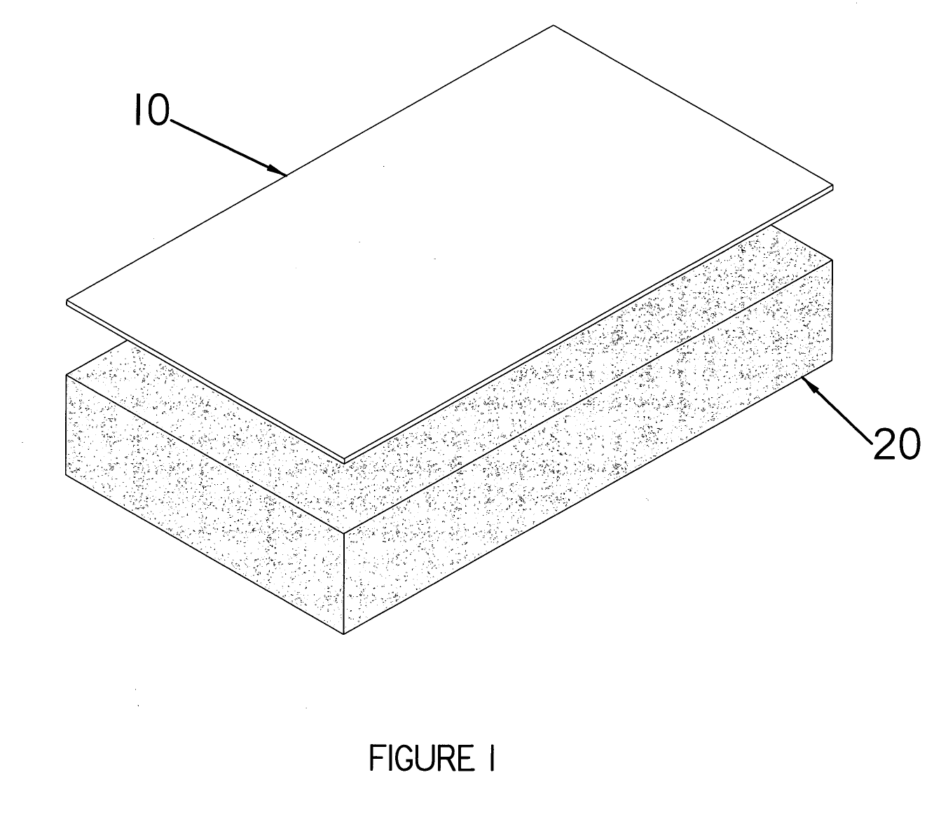

FIG. 1 shows construction of one of these plates. A conducting material 20 is coated with a thin insulating dielectric layer 10 coated with a thin lamina of Matrix material. The preferred embodiment of the invention utilizes Teflon (PTFE) as the thin insulating dielectric layer 10 to be coated upon the conductive material. The conductive material 20 could be any range of metals or even a conductive polymer. The preferred embodiment utilizes stainless steel.

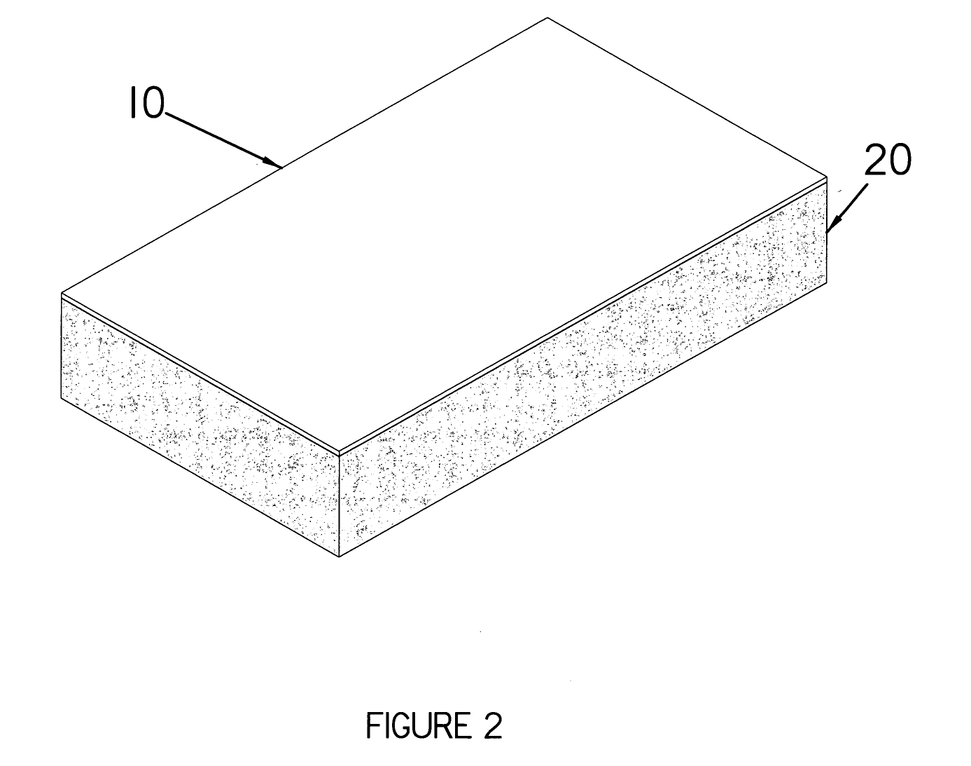

FIG. 2 shows completed construction of one of these small sample plates. A conducting material 20 is coated with a thin insulating dielectric layer 10 coated with a thin lamina of Matrix material. The conductive material 20 would later be connected to a high voltage source that would provide a voltage differential between the sample and the conductive plate 20. When an electric field is applied to the conductive plate 20, and coupled to a sample material or solution, the result is that the insulating dielectric layer 10 would facilitate the removal of cations or anions from the solution or material. Depending on the polarity of the applied voltage, cations or anions would be pulled from the solution when applying it to the surface of the insulating dielectric layer 10. The thin dielectric layer 10 is coated with a thin lamina of Matrix prior to its use. When the electric field is removed, the charges will remain on the Matrix coated, thin insulating layer surface 10 for some time. The result is that when the coated plate (10 & 20) is placed in the MALDI-TOF mass spectrometer, instead of singly charged ions being created, multiply charged ions can now be created. One could simply rub ones finger over the surface of the thin insulating dielectric layer 10, while applying a charge, to capture small amounts a sample material.

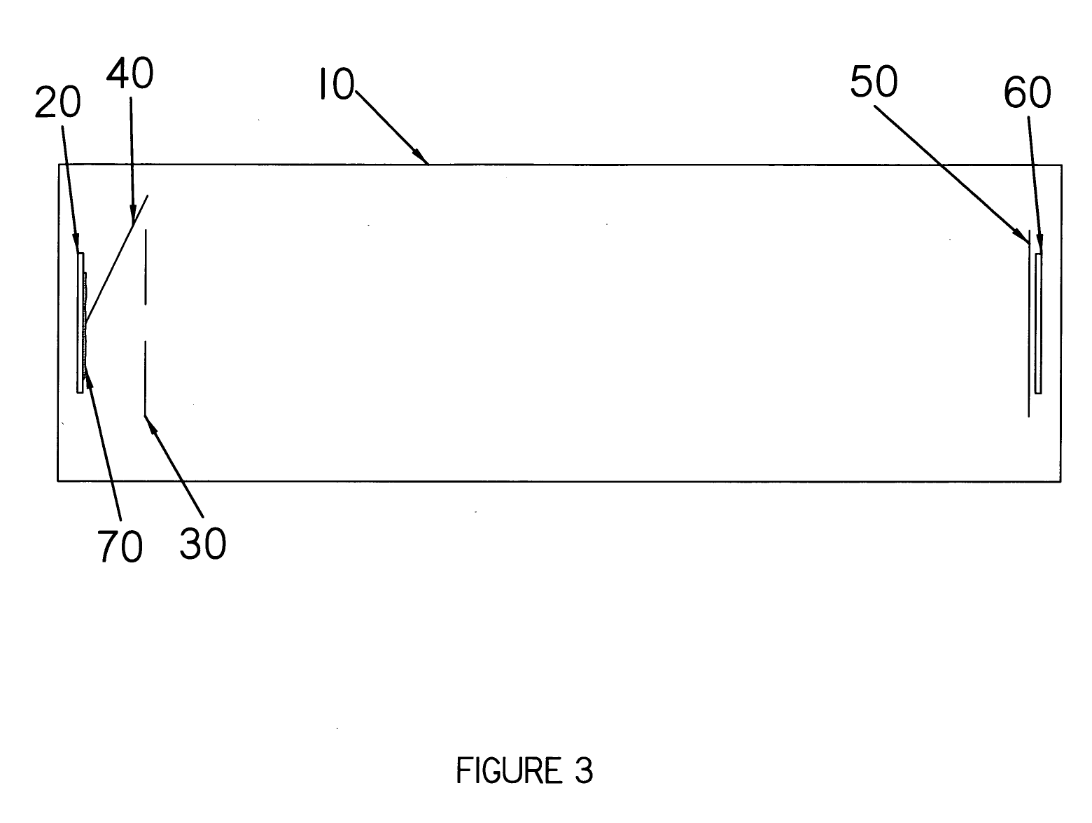

FIG. 3 shows a schematic drawing of a flight tube section of a linear TOF (Time Of Flight) mass spectrometer using the MALDI technique. The TOF-MS tube must be run in vacuum to give accurate results, and therefore is contained in an airtight rigid tube 10. The principal of TOF-MS is very basic, in that when an analyte material is ionized and placed in the gas phase, a separation of charged masses ensues within a “field free” region of known length. The “field free” region ensures that no external acceleration or retardation will affect the charged masses. The basic premise is that smaller masses will travel faster (and further) in unit time than will large ones. Obviously, the longer the TOF-MS flight tube 10, the greater the amount of separation will occur. A device called a Reflectron (not shown here) is commonly used to enable a short TOF-MS flight tube 10 to have a greater path of travel. The basic TOF-MS consists of a rigid, evacuated tube 10, containing the sample to be ionized 70. A plate or electrode 20 containing a material to be ionized 70 by the UV laser 40 is held at the back of the evacuated TOF-MS tube 10. Two electrodes 30 and 50 are separated by a known distance. Both electrodes 30 and 50 are at ground potential, and thus the region between them is field free. Finally, a detector 60 is placed at the opposite end of the evacuated tube 10. Since a separation of charged masses will occur when ionized material is sent through the field free region of the flight tube, the smaller charged masses will strike the detector before the larger, slower charged masses. The result is that a series of peaks will be shown at the detector.

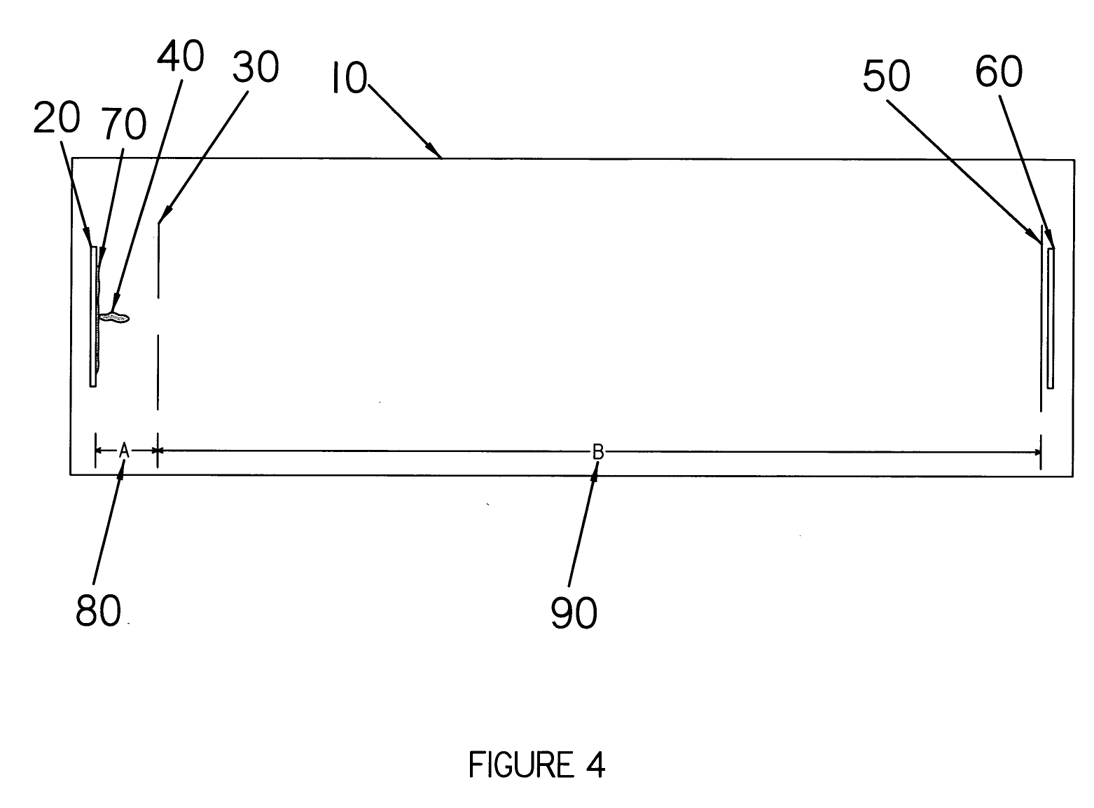

FIG. 4 shows a schematic drawing of a flight tube section of a linear TOF (Time Of Flight) mass spectrometer using the MALDI technique. After the UV laser pulse has ended, the plate or electrode 20 containing a sample material 70 has absorbed enough UV laser energy to become violently heated, and thus forms a plume of ionized sample material 40. Since the plume of sample material 40 is ionized, it is attracted to, or accelerated towards the first grounded grid 30. This region indicated by the letter “A” 80 is known as the acceleration region. The distance “A” 80 is known very precisely, and does not change. The first grounded grid 30 allows the ionized material to pass through with very little interaction. After the ions pass the first grounded grid 30, they are in a “field free” region between the two grounded grids (30 and 50). The distance between the two grounded grids (30 and 50), is indicated by distance “B” 90. With both distance “A” 80 and “B” 90 accurately known, detailed spectra of the sample material could be constructed.

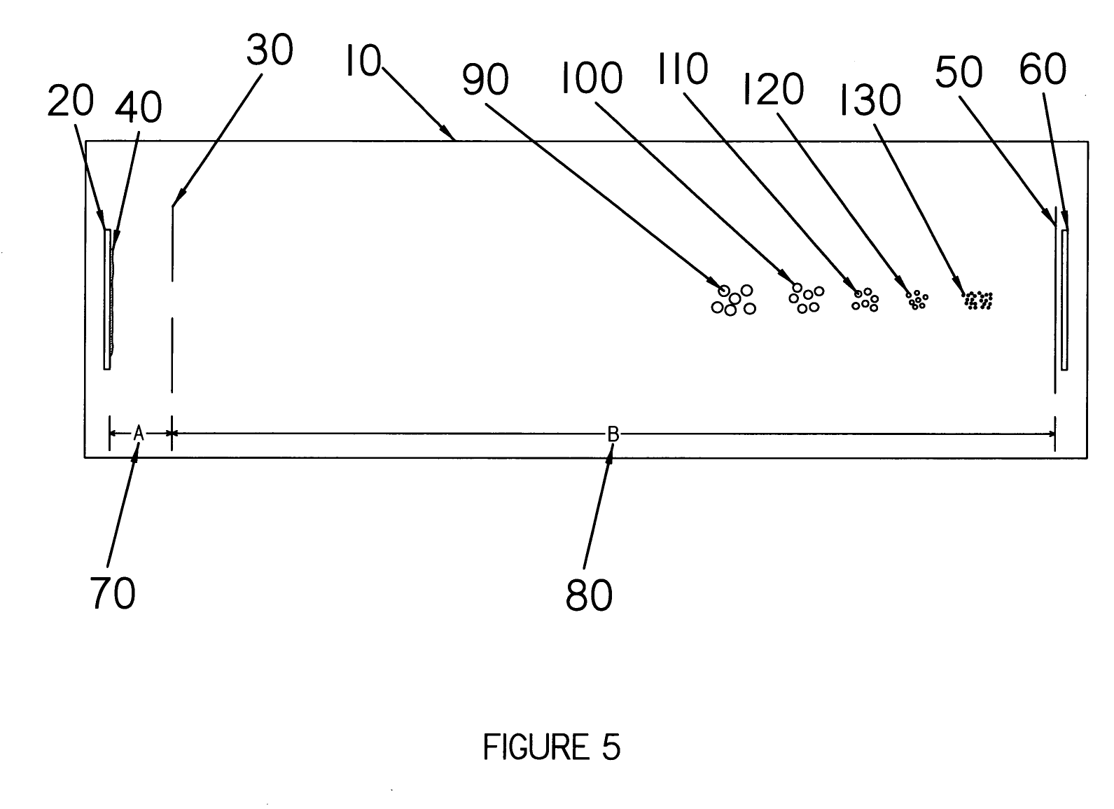

FIG. 5 shows a schematic drawing of a flight tube section of a linear TOF (Time Of Flight) mass spectrometer using the MALDI technique. After the UV laser pulse has ended, the plate or electrode 20 containing a sample material 70 has absorbed enough UV laser energy to become violently heated, and thus forms a plume of ionized sample material 40 that has been kicked off into the gas phase. Since the plume of sample material is ionized, it is attracted to, or accelerated towards the first grounded grid 30. This region indicated by the letter “A” 80 is known as the acceleration region. The distance “A” 80 is known very precisely, and does not change. The first grounded grid 30 allows the ionized material to pass through with very little interaction. After the ions pass the first grounded grid 30, they are in a “field free” region between the two grounded grids (30 and 50). The distance between the two grounded grids (30 and 50), is indicated by distance “B” 90. With both distance “A” 80 and “B” 90 accurately known, detailed spectra of the sample material could be constructed. The spectra arise due to the separation of charged masses. As the ionized plume of sample material separates into groups of charged masses, the largest charged masses 90 will travel the slowest, with the next smallest charged masses 100 moving slightly faster, the next smallest charged masses 110 slightly faster, the next smallest charged masses 120, slightly faster, and the smallest charged masses 130 traveling the fastest. The resulting impact with each of these charged masses with the detector 60 allows for detailed spectra to be recorded.

FIG. 6 indicates a schematic drawing of the combination ESMALDI-MS technique. The small conductive metal plates 70 coated with a thin insulating dielectric layer 60 coated with a thin lamina of Matrix were first described in figures one and two. The analyte and solvent solution 20 is contained inside the sample introduction cell 10. When a high voltage source 80 is connected between the sample introduction cell 10 and the metal plate 70 coated with a thin insulating dielectric layer 60, a resulting electrospray is created. Electrospray ionization is a process that enables the creation of multiply charged ions to be created. It is this use of electrospray that will enable the standard MALDI technique to be enhanced by the creation of multiply charged ions, and thus ESMALDI. Electrosprays are an advanced stage of the phenomenon known as Zeleny-Taylor cones. When a liquid drop is subjected to an electric field, it will become slightly elongated in the direction of the field. Since the dielectric constant of the drop is larger than that of the surrounding air, the elongation of the drop effectively channels more of the field inside the dielectric material, lowering the overall energy stored in the electric field. This elongation is opposed by the surface tension of the drop, which tends to keep the drop close to spherical shape. As the field is increased, the drop will continue to deform from its preferred spherical shape, and as the tip of the drop reduces its radius of curvature, more electric field is concentrated at this point. This mechanism feeds back into further deformation. At a critical field and deformation known as the Rayleigh limit, the rate of energy gained by raising the electric field inside the dielectric drop is no longer offset by the energy lost due to surface tension, and the drop unstably progresses toward a very sharp tip. This phenomenon we first seriously studied by Zeleny around 1915. G. I. Taylor published a famous paper where he calculated the angle of the conical drop. Since then, the drops are called Zeleny-Taylor cones, or simply Taylor cones. A major portion of any ESIMS is that of the hydrostatic feed system. The hydrostatic feed system must be capable of delivering a tiny amount (microliter to nanoliter quantity) of liquid at a controlled rate to effect a stable Taylor cone. The disclosed invention will use a small section of “Holey fiber” to act as the small, wick filled needle source for electrospray applications. The fact that there will be no moving parts in this self-regulating liquid delivery source means that the reliability and longevity will be greatly enhanced. The Holey fiber wick is capable of delivering a regulated flow rate down to a range of Picoliters [10⁻¹² L] per second. To design a small syringe pump to do the same job would be extremely costly to implement. The wick in the sample introduction cell 30 is a “Holey fiber” but a typical hollow needle and syringe pump will also work. When the high voltage source 80 is connected to the sample introduction cell 10 via connection 90, and the small conductive metal plate 70 via connection 100, an electric field is produced between the metal plate 70 and the tip of the sample introduction source 10. This electric field establishes the creation of a “Taylor cone” and a resulting jet of multiply charged droplets 40. The jet of ionized droplets 40 contains a solution of analyte and solvent 20. As the jet of ionized material 40 is sprayed onto the surface of the thin insulating dielectric layer 60 coated with a thin lamina of Matrix, a small pool of solution builds up 50. This pool of solution 50 is composed of a solvent and analyte solution that is multiply charged. Because typical applications will use very minute quantities of solution will be used, and the solution pool 50 is greatly exaggerated for purposes of illustration.

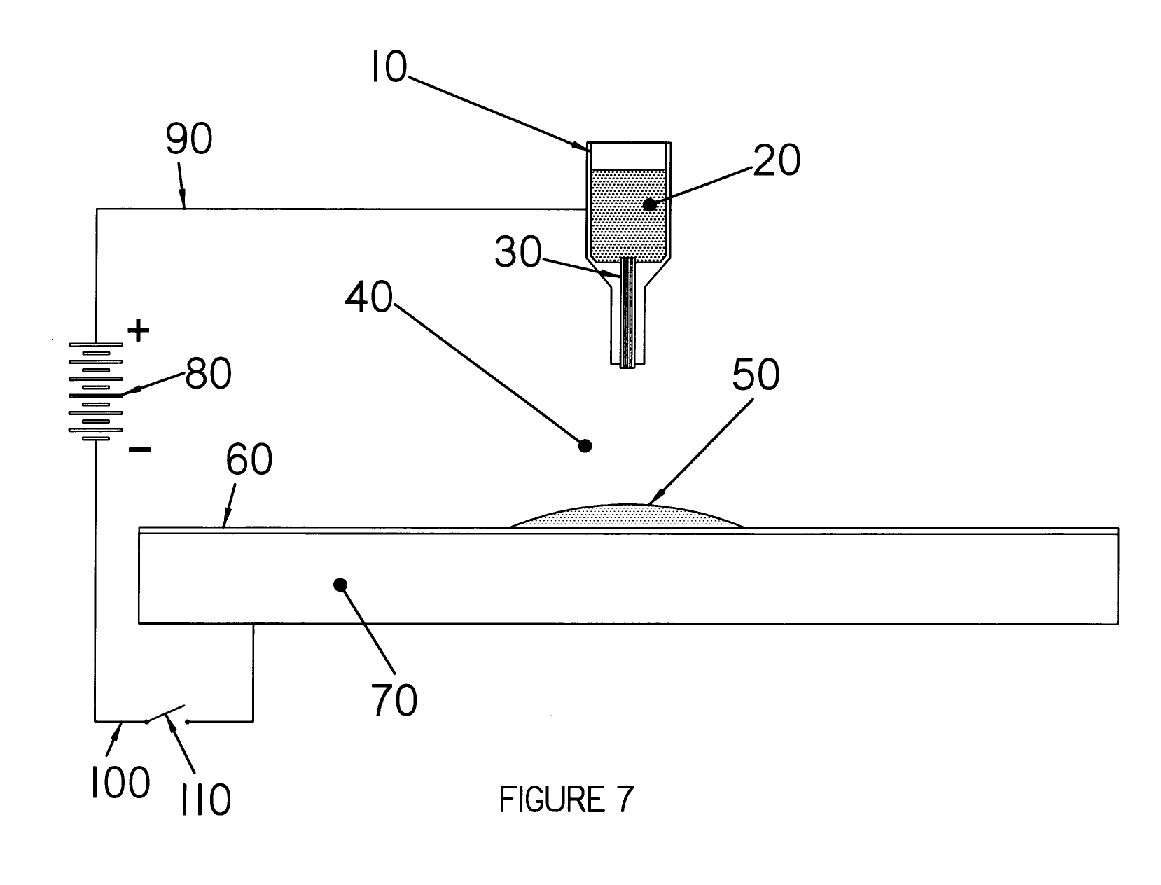

FIG. 7 indicates a schematic drawing of the combination ESMALDI-MS technique. The small conductive metal plates 70 coated with a thin insulating dielectric layer 60 were first described in figures one and two. The solvent and analyte solution 20 is contained inside the sample introduction cell 10. When the high voltage source 80 is disconnected from the circuit by opening switch 110, the electrospray process stops, and the resulting jet of ionized droplets 40 disappears. When the electrospray process was running, a small pool of solution was built up 50. This pool of solution 50 is composed of a solvent and analyte solution and is placed upon the thin lamina of Matrix. When UV laser energy is absorbed by the pool of solution 50, it is sent into the gas phase as a plume of multiply charged ions. This described invention will allow for a much more efficient and sensitive MALDI technique of TOF-MS.

### REFERENCE NUMERALS

FIG. 1:
10 A thin layer of an insulating dielectric, such as Teflon that can be applied or coated onto a conducting metal electrode coated with a thin lamina of Matrix material.
20 A small metal electrode to be coated with an insulating dielectric material.
FIG. 2:
10 A thin layer of an insulating dielectric, such as Teflon that can be applied or coated onto a conducting metal electrode coated with a thin lamina of Matrix material.
20 A small metal electrode to be coated with an insulating dielectric material.
FIG. 3:
10 A rigid, airtight tube.
20 A plate containing the electrosprayed solution and thin lamina of matrix material.
30 A grid that is tied to ground potential.
40 A beam of ultraviolet laser light emitted from the ultraviolet laser.
50 A grid that is tied to ground potential.
60 A detector that will indicate when charged particles make contact with it.
70 A thin layer of matrix and sample solution that has been ionized.
FIG. 4:
10 A rigid, airtight tube.
20 A plate containing the electrosprayed solution and thin lamina of matrix material.
30 A grid that is tied to ground potential.
40 A plume of solution and Matrix induced into the gas phase by the UV laser.
50 A grid that is tied to ground potential.
60 A detector that will indicate when charged particles make contact with it.
70 A thin layer of matrix and sample solution that has been ionized.
80 A region of acceleration that had its length carefully measured.
90 A region of “Field free” space that had its length carefully measured.
FIG. 5:
10 A rigid, airtight tube.
20 A plate containing the electrosprayed solution and thin lamina of matrix material.
30 A grid that is tied to ground potential.
40 A thin layer of matrix and sample solution that has been ionized.
50 A grid that is tied to ground potential.
60 A detector that will indicate when charged particles make contact with it.
70 A region of acceleration that had its length carefully measured.
80 A region of “Field free” space that had its length carefully measured.
90 A group of large charged masses traveling through the “Field free” zone.
100 A group of slightly smaller charged masses traveling through the “Field free” zone.
110 A group of slightly smaller charged masses traveling through the “Field free” zone.
120 A group of slightly smaller charged masses traveling through the “Field free” zone.
130 A group of the smallest charged masses traveling through the “Field free” zone.
FIG. 6:
10 A conductive sample introduction cell.
20 A solution of solvent and analyte contained inside the conductive sample introduction cell.
30 A section of “Holey fiber”.
40 A jet of ionized droplets created by the electrospray process.
50 A small pool of ionized droplets created by the electrospray process.
60 A thin layer of an insulating dielectric, such as Teflon that can be applied or coated onto a conducting target that is coated with a thin lamina of Matrix.
70 A metal electrode to be coated with an insulating dielectric material.
80 A high voltage source.
90 A wire connector that will enable electrical connection from the high voltage source to the sample introduction cell.
100 A wire connector that will enable electrical connection from the high voltage source to the electrode.
FIG. 7:
10 A conductive sample introduction cell.
20 A solution of solvent and analyte contained inside the conductive sample introduction cell.
30 A section of “Holey fiber”.
40 An area of space indicating that the jet of ionized droplets created by the electrospray process has stopped.
50 A small pool of ionized droplets created by the electrospray process.
60 A thin layer of an insulating dielectric, such as Teflon that can be applied or coated onto a conducting metal electrode that is coated with a thin lamina of Matrix.
70 A metal electrode to be coated with an insulating dielectric material.
80 A high voltage source.
90 A wire connector that will enable electrical connection from the high voltage source to the sample introduction cell.
100 A wire connector that will enable electrical connection from the high voltage source to the electrode.
110 A high voltage switch.

We claim the following:

1. a method of enhancing the MALDI (Matrix Assisted Laser Desorption Ionization) mass spectrometric process by utilizing ESI (ElectroSpray Ionization) to spray a multiply charged sample solution onto a MALDI Matrix whereby:
a. the thin lamina of MALDI Matrix is coated onto a thin layer of dielectric material that has been previously coated onto a conductive plate.
b. a sample solution is Electrosprayed onto the thin lamina of Matrix material.
c. the conductive plate with dielectric coating, Matrix and sample solution is placed into a TOF (Time Of Flight) mass spectrometer for analysis.
